(19) United States
(12) Patent Application Publication
(10) Pub. No.: US 2013/0260135 A1
(43) Pub. Date: Oct. 3, 2013

(54) Introduction of stable inclusions into nanostructured thermoelectric materials

(71) Applicant: EVIDENT TECHNOLOGIES, INC., Troy, NY (US)

(72) Inventors: Clinton T. Ballinger, Ballston Spa, NY (US); Adam Z. Peng, Guilderland, NY (US); Susanthri Perera, Latham, NY (US)

(73) Assignee: Evident Technologies, Inc., Troy, NY (US)

(21) Appl. No.: 13/853,304

(22) Filed: Mar. 29, 2013

Related U.S. Application Data
(60) Provisional application No. 61/618,109, filed on Mar. 30, 2012.

(51) Int. Cl. B32B 3/26

(52) U.S. Cl. CPC B32B 3/26
USPC 428/319.9; 264/109; 428/304.4

(57) ABSTRACT

Disclosed is a method of consolidating a powder. The method can include obtaining a powder of semiconductor nanocrystals, obtaining a material which will form a gas when heated, and combining the powder and the material into a combined powder. The method can also include consolidating the powder by applying heat and pressure to the combined powder.

### CROSS-REFERENCE TO RELATED APPLICATIONS

This application claims the benefit of co-pending U.S. Provisional Application Ser. No. 61/618,109, filed 30 Mar. 2012, which is hereby incorporated by reference herein.

### FIELD OF THE INVENTION

Embodiments of the present disclosure relate generally an increased thermoelectric performance of nanocrystals by introducing inclusion materials and gas voids into a consolidated material. Embodiments include introducing volatile compounds to powdered nanocrystals.

### BACKGROUND OF THE INVENTION

The electrical conductivity and the thermal conductivity of a material are inherently coupled. This has been the subject of study for decades. The celebrated Wiedemann-Franz law describes the relationship between the electrical and thermal conductivities. This is confounding for many interested in improving the performance of thermoelectric material. The goal for such a material is to have the lowest possible thermal conductivity with the highest possible electrical conductivity. Realistically, this is only accomplished by manipulating the lattice component to affect the thermal conductivity. The electrical component to the thermal conductivity is inherently coupled to the electrical conductivity of the material.

Previous attempts to reach this goal have used dopants, impurities for scattering, rattlers like those found in skutterudites, grain boundaries, and the like for years in an effort to reduce the lattice contribution to the thermal conductivity. However, results have been very limited.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows a cross-section view of a consolidated material that may include embodiments of the invention disclosed herein.

FIG. 2 shows a cross-section view of a consolidated material that may include embodiments of the invention disclosed herein.

It is noted that the drawings may not be to scale. The drawings are intended to depict only typical aspects of the invention, and therefore should not be considered as limiting the scope of the invention. In the drawings, like numbering represents like elements between the drawings. The detailed description explains embodiments of the invention, together with advantages and features, by way of example with reference to the drawings.

### SUMMARY OF THE INVENTION

A first aspect of the present invention includes a method of consolidating a powder comprising: obtaining a powder of semiconductor nanocrystals; obtaining a material which will form a gas when heated; combining the powder and the material into a combined powder; and consolidating the powder into a consolidated material by applying heat and pressure to the combined powder.

A second aspect of the present invention includes a method of consolidating a powder comprising: obtaining a powder of semiconductor nanocrystals; obtaining an inclusion material; combining the powder and the inclusion material into a combined powder; and consolidating the powder into a consolidated material by applying heat and pressure to the combined powder.

A third aspect of the present invention includes a consolidated material comprising: a plurality of semiconductor nanocrystals in a lattice structure; and a plurality of gas filled voids within the lattice structure.

### DETAILED DESCRIPTION OF THE INVENTION

It is understood that there is a competition between the electrical conductivity and the thermal conductivity when making thermoelectric materials. The highest performing thermoelectric (TE) materials should possess low thermal conductivities and high electrical conductivities. However, these two properties are intimately connected. The thermal conductivity in fact has an electronic component that is directly proportional to the electrical conductivity. Hence a large electrical conductivity will typically result in a large electronic component to the thermal conductivity.

Disclosed herein is a novel approach of creating gas-filled stable voids in a consolidated material. In addition to the thermal conductivity benefits, these void regions can inhibit grain growth of the material.

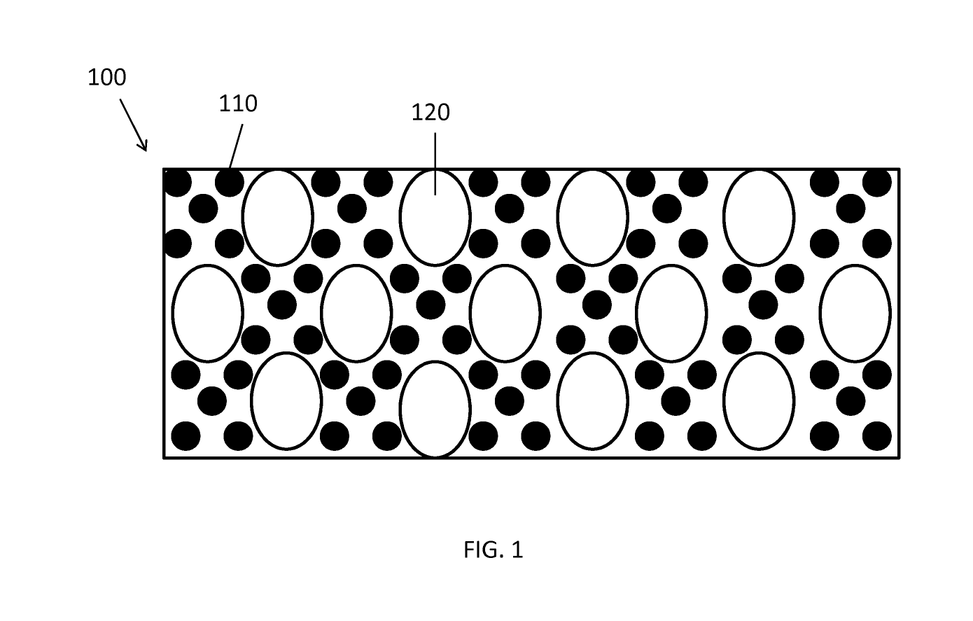

Turning to FIG. 1, in some embodiments of the current invention, the disclosed consolidated material 100 can help to modify the lattice component of consolidated material 100 in order to affect the thermal conductivity. According to these embodiments, the consolidated material 100 made using these methods can help increase the quantum confined properties of the semiconductor nanocrystals 110 used in consolidated material 100. Quantum confinement, a property unique to some nanomaterials, is usually lost when particles of nanomaterials are in intimate contact with particles of the same material. Accordingly, when a powder of semiconductor nanocrystals 110 is consolidated, the close proximity of semiconductor nanocrystals 110 can often reduce, or even eliminate, the extent of quantum confinement properties of consolidated material 100.

In one embodiment of the current invention, semiconductor nanocrystals 110 are utilized that have physical dimensions that are less than the Bohr radius of the material, leading to quantum confined effects. Further, semiconductor nanocrystals 110 may be colloidally grown nanocrystals. The physical dimensions of the Bohr radius vary based on the composition of the nanocrystal, but typically include at least one dimension being in the range of approximately 1 nm to 30 nm. However, when these nanocrystals are assembled into a solid such that the nanocrystals are in intimate contact with one another, the quantum confined effects can be lost as the properties of such close nanocrystals can take on the properties of a bulk material. Accordingly, in the prior methods, a consolidated material would act as a bulk material of the nanocrystals used.

The inventors have found that at a high level, the electronic band structure of an individual nanocrystal may give way to the ensemble band structure of the solid material since there is no discernible distance between the nanocrystals when they are in contact with one another. The electrons are no longer “quantum confined” as they are free to pass from nanocrystal to nanocrystal without even noticing a change. If the nanocrystals were separated by a different material, especially one with a higher bandgap energy, the effects of quantum confinement can be reestablished within the nanocrystals. In many previous instances, it was undesirable to introduce a matrix material made of higher bandgap semiconductor material as a spacer between the embedded nanocrystals. In thermoelectric applications, for example, the performance of a composite like this is typically limited to the lowest performing semiconductor material in the system. It can be difficult to select two high performing semiconductor materials which can be utilized to create this matrix-nanocrystal assembly where quantum confinement is preserved. An alternative, as discussed herein, is to introduce gas filled voids 120 into consolidated material 100.

Gas filled voids 120 can be created in consolidated material 100 in a number of ways. For instance, gas filled voids 120 can be created by not fully drying a powder containing semiconductor nanocrystals 110 prior to consolidation of the powder. The powder may consist of a plurality of semiconductor nanocrystals 110, which may consist of one or more populations of nanocrystals. The one or more populations may include the same or different compositions of material and the same or different sizes of the nanocrystals. For instance, in creating gas voids 120, if a volatile solvent, which in some embodiments may include ether, is introduced in a controlled amount to the powder, the process of consolidation can cause the volatile solvent to vaporize. However, the pressure of consolidation may not allow the gas to escape when the volatile solvent vaporizes. This can result in a plurality of gas filled voids 120 within consolidated material 100, which are filled with the gas released by the volatile solvent being present in the material after consolidation of the powder.

In further embodiments, consolidated material 100 may be heat treated following consolidation of the powder. In these embodiments, the gas in the gas filled voids 120 may expand during heating. This expansion of the gas within gas filled void 120 can cause the lattice of the material, which can be seen as an illustration of the approximate pattern in FIG. 1, to be more relaxed. As shown in FIG. 1, a lattice has formed from the consolidation of semiconductor nanocrystals 110 and gas filled voids 120. It is to be understood that this is just an illustration of a lattice structure, and many different lattice shapes are possible. Returning to the embodiments described, an expansion of gas filled voids 120 and the resulting relaxed lattice structure can lead to a lower density consolidated material 100 with larger gas filled voids 120. The heat treatment can be performed as a post-consolidation treatment, or alternatively, may be performed during the consolidation step by reducing the pressure at an appropriate time as consolidated material 100 is cooling.

In other embodiments, there are some materials that can be added to consolidated material 100 that will volatilize during the heating phase of the consolidation process, which may also then cool and become a solid at the operational temperatures. The materials could include, as one example, hydrocarbons. In this embodiment, the hydrogen and carbon bonds may actually break during the heating involved in consolidation, leaving a carbon residue inside gas filled voids 120. This can be beneficial as the carbon residue can act to reduce the thermal conductivity of consolidated material 100. Further the carbon residue can act as a grain growth inhibitor for consolidated material 100, helping maintain the nanoscale of semiconductor nanocrystals 110.

In further embodiments, materials that undergo a phase change at the thermoelectric operational temperature may be ideally suited to reduce the thermal conductivity. For example, if the end application requires operating temperatures around 100° C., trapping water inside gas filled voids 120 could greatly reduce the thermal conductivity as the water will undergo a phase transformation to a gas. Although water is one example, there are other known volatile materials that don't have the oxidizing effect that water has. Some non-limiting examples include ether, alcohol, and hydrazine, which can all be introduced to the powder containing semiconductor nanocrystals 110 in order to create gas filled voids 120.

In ideal thermoelectric situations, it would be beneficial if each individual nanocrystal was surrounded by a gas or a void, such as gas filled voids 120. In such a scenario, quantum confined effects would likely be present to a larger degree than usual. However, it is difficult if not impossible to create a solid material that has free-floating semiconductor nanocrystals 110. This ‘ideal’ structure can, however, be approximated using an aerogel-type of scaffolding, or to some extent, by introducing gas filled voids 120 in the material. The electronic band structure for the semiconductor nanocrystals 110 that are close to the regions of gas filled voids 120 may exhibit more quantum confined behavior than those close to solid structures.

The nanoscale size can impact the lattice thermal conductivity without affecting the Seebeck coefficient of the material. In order to create an effective thermoelectric material, it can be helpful to insulate the nanocrystals, causing the electrons to have to ‘hop’ from one isolated nanocrystal to another. Such insulation can come, in part, from gas filled voids 120. There can be in increase in the Seebeck coefficient when the above disclosed gas filled voids 120 are present, as a portion of the nanocrystal is essentially confined.

Typical mean free path (MFP) for charge carriers in average semiconductor materials are on the order of about 100 nm. This is far larger than the physical dimension of semiconductor nanocrystals 110, which are typically only a few nanometers, sometimes between about 2 and 20 nm. In consolidated material 100 containing gas filled voids 120 surrounding each semiconductor nanocrystal 110, or at least many of them, semiconductor nanocrystals 110 could be considered quantum confined more effectively than if the nanocrystals are in close contact with one another. In such a material, heat will not transfer so easily via lattice vibrations, as there is effectively little or no lattice structure within gas filled voids 120. Since the charge carrier's MFP is larger than the physical dimension of semiconductor nanocrystals 110, and larger than the typical gas filled voids 120 within consolidated material 100, electrons and other charge carriers may be capable of travelling through a number of other semiconductor nanocrystals 110, as well as gas filled voids 120, with little energy lost to any thermal losses. Thus, the Seebeck coefficient is enhanced with stable inclusions and void integration in a thermoelectric material.

It is understood that an efficient thermoelectric material is one with a delta-function density of states. This density of states may be approximated by a spaced super lattice of semiconductor nanocrystals 110 of the same size and stoichiometry. The disclosed consolidated material 100 approaches the density of states.

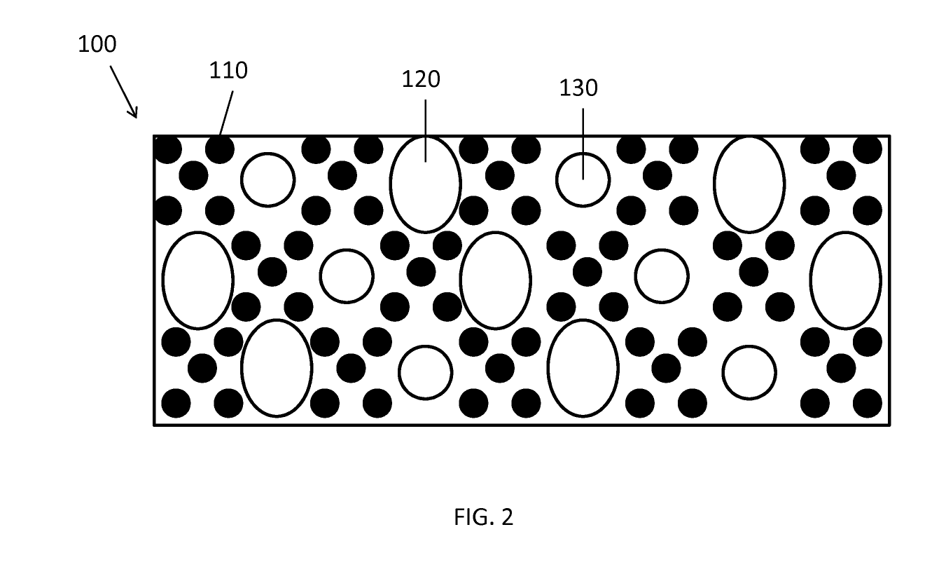

In further embodiments, as illustrated in FIG. 2, introducing an inclusion material 130 to consolidated material 100 that will withstand the rigors of consolidation can be another way to increase the thermoelectric performance of consolidated material 100. Once the powder of semiconductor nanocrystals 110 is ready for consolidation, nano or micro particles of other materials having a higher melting point can be introduced. The introduction of these ‘foreign’ inclusion materials 130 with a higher melting point can increase the thermoelectric performance as they will not easily bond to the lattice structure of consolidated material 100. As such, inclusion materials 130 could act as a “rattler” to reduce the lattice thermal conductivity that can happen from vibrations of the lattice structure of consolidated material 100.

Some non-limiting examples of inclusion materials 130 can include nanoscale titania, nanoscale alumina, and other nanoscale oxides, as well as micro-sized glass beads or even elemental materials such as elemental sulfur. Other elemental materials may be used as well, such as carbon and silicon. Although illustrated in FIG. 2 as being used in conjunction with gas filled voids 120, it should be understood that inclusion materials 130 can be used alone with semiconductor nanocrystals 110, or in combination with gas filled voids 120. Further, inclusion materials 130 may comprise one or more types of inclusion material. It should be understood that inclusion material 130 can include different sizes and shapes of material, and thus the lattice structure shown and distribution of inclusion materials 130, as well as gas filled voids 120, are only illustrative.

In addition to the “rattler” affect described above, since the disclosed inclusion materials 130 are typically all higher bandgap materials, the electron band structure of semiconductor nanocrystals 110 directly adjacent to inclusion materials 130, which in some cases can be considered impurities, will be less like those of the bulk material and more like that of pure unattached nanocrystals 110, i.e., quantum confined. This is aligned with the basic notion that the lower the density of states, the larger the enhancement to the thermoelectric performance. In a further embodiment, semiconductor nanocrystals 110 included in materials which can form a nanoporous matrix, such as, xerogels, aerogels, nanoporous silicon, or semiconductor nanocrystals 110 mixed with high index glass beads or nano titania, in order to form consolidated material 100, can all demonstrate this increased thermoelectric property by creating such a lattice structure and at least partially isolating one or more semiconductor nanocrystals 110 within the lattice structure.

As a further benefit of the disclosed gas filled voids 120 and/or inclusion materials 130 in a consolidated material 100, the different gas filled voids 120 and inclusion materials 130 disclosed can also act as a grain growth inhibitor in the material. Grain growth within consolidated material 100 can decrease the effectiveness of the material, as the grains can reduce the quantum confined properties of the end material. Further, they can reduce the lattice structure's thermal conductivity in the final material.

The consolidated material as described in the above embodiments can be useful for many applications. For instance, due to the unique structure, consolidated material 100 can be effective as a thermoelectric device or part of a thermoelectric device. However, this is not meant to be limiting.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed:

1. A method of consolidating a powder comprising:
obtaining a powder of semiconductor nanocrystals;
obtaining a material which will form a gas when heated;
combining the powder and the material into a combined powder; and
consolidating the powder into a consolidated material by applying heat and pressure to the combined powder.

2. The method of claim 1, wherein the material is a material which will dissociate during the consolidation.

3. The method of claim 2, wherein the material is a hydrocarbon.

4. The method of claim 1, wherein the material is a volatile material.

5. The method of claim 4, wherein the volatile material is a liquid chosen from a group consisting of: ether, methanol, and hydrazine.

6. The method of claim 4, wherein the volatile material will undergo a phase change at a temperature of the consolidation.

7. A method of consolidating a powder comprising:
obtaining a powder of semiconductor nanocrystals;
obtaining an inclusion material;
combining the powder and the inclusion material into a combined powder; and
consolidating the powder into a consolidated material by applying heat and pressure to the combined powder.

8. The method of claim 7, wherein the inclusion material comprises an oxide that is stable at high temperatures.

9. The method of claim 8, wherein the oxide is chosen from a group consisting of: titania, alumina, and silica.

10. The method of claim 7, wherein the inclusion material comprises an elemental material.

11. The method of claim 10, the elemental material being chosen from a group consisting of: sulfur, carbon, and silicon.

12. A consolidated material comprising:
a plurality of semiconductor nanocrystals in a lattice structure; and
a plurality of gas filled voids within the lattice structure.

13. A consolidated material comprising:
a plurality of semiconductor nanocrystals in a lattice structure; and
wherein the lattice structure comprises a nanoporous matrix material.

14. The consolidated material of claim 13, wherein the nanoporous matrix material comprises a xerogel.

15. The consolidated material of claim 13, wherein the nanoporous matrix material comprises an aerogel.

16. The consolidated material of claim 13, wherein the nanoporous matrix material comprises a nanoporous silicon.
